(19) United States
(12) Patent Application Publication
(10) Pub. No.: US 2009/0167636 A1
(43) Pub. Date: Jul. 2, 2009

(54) Mobile signal processing apparatus and wearable display

(75) Inventors: Shigeru Kato, Kawasaki-shi (JP); Masaki Otsuki, Yokohama-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/320,562

(22) Filed: Jan. 29, 2009

Related U.S. Application Data
(63) Continuation of application No. PCT/JP2007/000878, filed on Aug. 15, 2007.

(30) Foreign Application Priority Data
Aug. 21, 2006 (JP) 2006-224538

(51) Int. Cl. G09G 5/00; G06F 17/00

(52) U.S. Cl. 345/7; 700/94

(57) ABSTRACT

A proposition is to provide a mobile signal processing apparatus and a wearable display capable of reducing a trouble of a user relating to an audio quality setting and an image quality setting. A mobile signal processing apparatus includes an audio adjusting unit adjusting audio output from mobile acoustic devices, an image adjusting unit adjusting an image displayed on a mobile displaying device, and a deciding unit deciding a combination between a setting of the audio adjusting unit and a setting of the image adjusting unit in accordance with a usage status of the mobile acoustic devices and the mobile displaying device.

### CROSS-REFERENCE TO RELATED APPLICATION

This application is a Continuation Application of International Application No. PCT/JP2007/000878, filed Aug. 15, 2007, designating the U.S., in which the International Application claims a priority date of Aug. 21, 2006, based on prior filed Japanese Patent Application No. 2006-224538, the entire contents of which are incorporated herein by reference.

### BACKGROUND

1. Field

The present embodiments relate to a mobile signal processing apparatus applied for a head mount display (hereinafter, referred to as an “HMD”) with headphone and so on, and a wearable display such as the HMD.

2. Description of the Related Art

There is a possibility that an HMD being a mobile apparatus (refer to Japanese Unexamined Patent Application Publication No. 2004-233903, and so on) is used under various environments such as an indoor environment, on train, an outdoor environment, at a dark place. Accordingly, it is necessary to appropriately change contents of an audio quality setting, an image quality setting of the HMD so as to comfortably appreciate the contents.

For example, it is preferable to display an image brighter because external world is bright in outdoor use, and it is preferable to display the image darker because the external world is dark in indoor use. Besides, it is preferable to output treble and extra bass lower so as to prevent sound leakage on train use.

Besides, there is a case when the audio quality setting and the image quality setting are effective depending on kinds of the contents even under the same environment. For example, it is easy to enjoy a live performance if the image is displayed brighter when the live performance is appreciated.

However, it takes a lot of trouble for the audio quality setting and the image quality setting, and therefore, it is too much of bother for a user to perform the settings every time when the environment and the kind of the contents change. In particular, the environment of the HMD being the mobile apparatus changes very frequently, and therefore, there is a high possibility that the user gives up to use the setting function in itself unless the trouble for the user is reduced.

### SUMMARY

A proposition of the present invention is to provide a mobile signal processing apparatus and a wearable display capable of reducing a trouble of a user for a setting relating to audio and a setting relating to an image.

A mobile signal processing apparatus of the present invention includes an audio adjusting unit adjusting audio output from mobile acoustic devices, an image adjusting unit adjusting an image displayed on a mobile displaying device, and a deciding unit deciding a combination between a setting of the audio adjusting unit and a setting of the image adjusting unit in accordance with a usage status of the mobile acoustic devices and the mobile displaying device.

Incidentally, the deciding unit may recognize the usage status by an input from a user.

Besides, the deciding unit may recognize the usage status by a signal from a sensor provided at least one of the mobile acoustic devices and the mobile displaying device.

Besides, a wearable display of the present invention includes mobile acoustic devices, a mobile displaying device, a mounting unit mounting the mobile acoustic devices and the mobile displaying device at a head part of a user, and the mobile signal processing apparatus according to any one of the present invention adjusting audio output from the mobile acoustic devices and adjusting an image displayed on the mobile displaying device.

### BRIEF DESCRIPTION OF THE DRAWINGS

FIG. 1 is an exterior view showing an overall configuration of a system.

FIG. 2 is a functional block diagram showing an electrical configuration of the system.

FIG. 3 is a functional block diagram of a signal processing part 210.

FIG. 4A to FIG. 4E are views showing displaying screens at an input time of a usage status.

FIG. 5 is a view showing information for AV setting stored by a controlling part 208 in advance.

FIG. 6 is a view showing an example of contents of the information for AV setting.

FIG. 7 is a functional block diagram showing an electrical configuration of a system of a second embodiment.

FIG. 8 is a functional block diagram showing an electrical configuration of a system of a third embodiment.

FIG. 9A to FIG. 9C are views showing displaying screens when a level of external illumination is enough high.

FIG. 10A to FIG. 10E are views showing displaying screens when a level of environmental sound is enough high.

### DETAILED DESCRIPTION OF THE EMBODIMENTS

### First Embodiment

Hereinafter, a first embodiment of the present invention is described. The present embodiment is an embodiment of an HMD system.

First, an overall configuration of the present system is described.

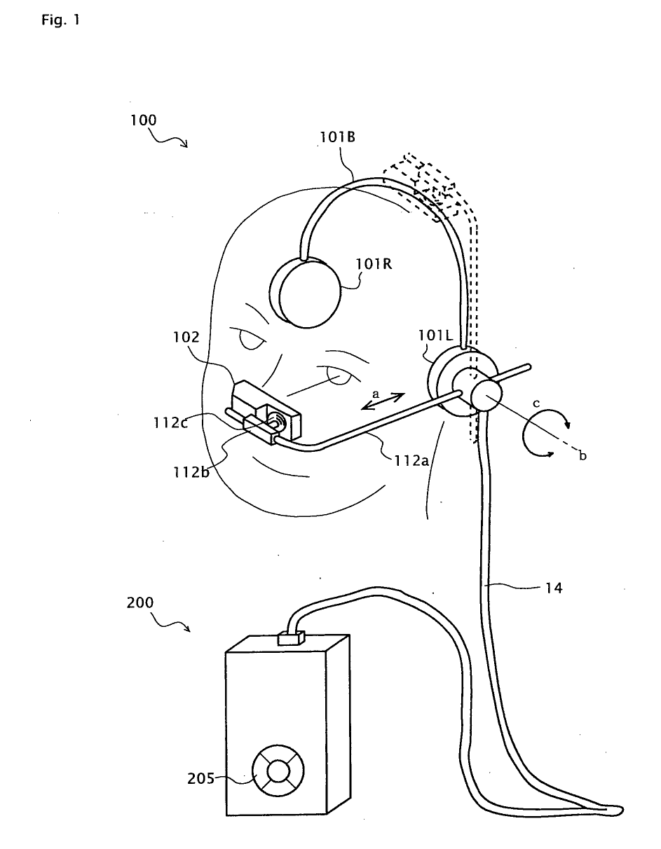

FIG. 1 is an exterior view showing the overall configuration of the present system. As shown in FIG. 1, the present system is made up of an HMD body 100 and a terminal 200, and both are electrically coupled via a cable 14.

The HMD body 100 includes a headband 101B, left and right headphones 101L, 101R provided at both ends of the headband 101, a supporting arm 112a coupled to the left headphone 101L, and a displaying part 102 coupled at a tip part of the supporting arm 112a.

The headphones 101L, 101R are abutted on left and right ears of a user, a vertex of the headband 101B is positioned in a vicinity of a top head part of the user, and the headphones 101L, 101R are pressed to the left and right ears of the user resulting from elastic force of the headband 101B to fix the whole HMD body 100 to the head part of the user. The supporting arm 112a correctly faces the displaying part 102 in front of a left eye (a viewing eye) of the user, as shown in FIG. 1 by a solid line under the above-stated state. Incidentally, a video displaying device, an optical system to enlargedly project the video displaying device on the viewing eye and so on are included in the displaying part 102.

A coupling point between the left headphone 101L and the supporting arm 112a is able to slide in an arrow “a” direction in FIG. 1, and is able to rotate in an arrow “c” direction (around an axis “b”) in FIG. 1. An interval between the displaying part 102 and the viewing eye is adjusted by sliding the supporting arm 112a in the direction “a”, and the displaying part 102 retreats from in front of the viewing eye by rotating the supporting arm 112a in the direction “c” as shown in a dotted line in FIG. 1.

Accordingly, the user mounting the HMD body 100 is able to move the supporting arm 112a with a hand if necessary to dispose the displaying part 102 at an appropriate distance in front of the viewing eye as shown by the solid line at an observation time, and to make the displaying part 102 retreat in the vicinity of the top head part as shown by the dotted line at a non-observation time.

Incidentally, a sliding member 112b and a spherical bearing 112c are provided at the coupling point between the displaying part 102 and the supporting arm 112a, and the user is able to perform a fine adjustment of a posture and a position of the displaying part 102 with the hand.

Contents files of contents to be appreciated by the user at the HMD body 100 are stored inside the terminal 200, and an operating switch 205 is provided at an outer package of the terminal 200. The operating switch 205 is made up of, for example, five kinds of buttons of an up button, a down button, a left button, a right button, and a decision button.

The user only inputs a reproducing indication of a contents file to the terminal 200 by operating this operating switch 205 to appreciate the contents. Besides, the user is also able to input a moving indication of a reproducing point, a pausing indication, an adjusting indication of audio volume, and a brightness adjusting indication of a video to the terminal 200 by operating the operating switch 205. Further, the user is also able to designate a usage status of the present system to the terminal 200 by operating the operating switch 205. Operations of the present system at the designation time are described later.

Next, an electrical configuration of the present system is described.

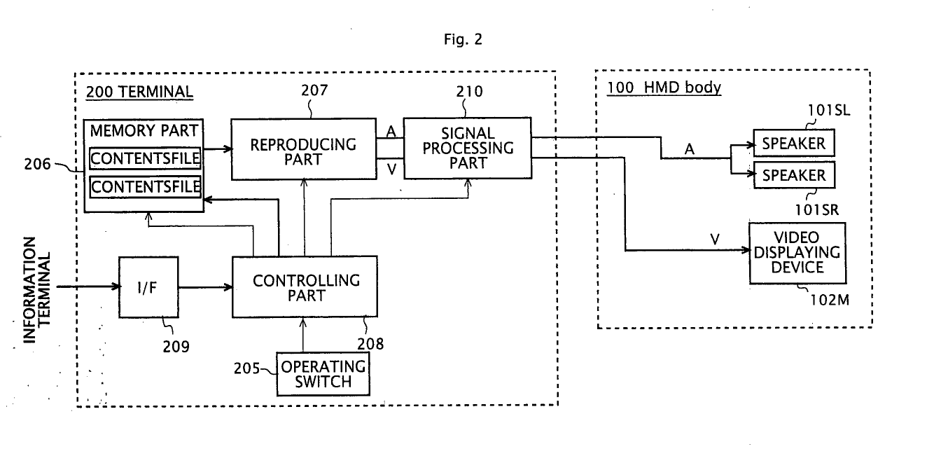

FIG. 2 is a functional block diagram showing the electrical configuration of the present system. As shown in FIG. 2, a memory part 206 such as a flash memory storing the contents files, a reproducing part 207 reproducing the contents file and generating a contents signal, a signal processing part 210 processing the contents signal generated by the reproducing part 207 in real time, an interface circuit 209 receiving the contents file from an external information terminal such as a computer, and a controlling part 208 controlling each part in accordance with operation contents of the operating switch 205 are included in the terminal 200.

Incidentally, the contents files stored in the memory part 206 of the terminal 200 are a video/audio contents file, an audio contents file without video, a video contents file without audio, and so on. A contents signal of the video/audio contents file is made up of an audio signal (A) and a video signal (V), a contents signal of the audio contents file without video is made up of the audio signal (A), and a contents signal of the video contents file without audio is made up of the video signal (V).

The controlling part 208 performs a generation and process of the contents signal (at least either one of the audio signal or the video signal) by operating the reproducing part 207 and the signal processing part 210 and transmits the contents signal after process to the HMD body 100, when the reproducing indication by the user is recognized from the operation contents of the operating switch 205. Besides, the controlling part 208 is also able to generate the video signal for an operation screen and transmit it to the HMD body 100 via the signal processing part 210 if necessary.

Left and right speakers 101SL, 101SR, and a video displaying device 102M are included in the HMD body 100. The left and right speakers 101SL, 101SR are each provided inside the left and right headphones 101L, 101R shown in FIG. 1, and the video displaying device 102M is disposed inside the displaying part 102 shown in FIG. 1. The audio signal (A) transmitted from the terminal 200 to the HMD body 100 is input to the speakers 101SL, 101SR, and converted into audio in real time. The video signal (V) transmitted from the terminal 200 to the HMD body 100 is input to the video displaying device 102M, and converted into video.

Next, the signal processing part 210 is described in detail.

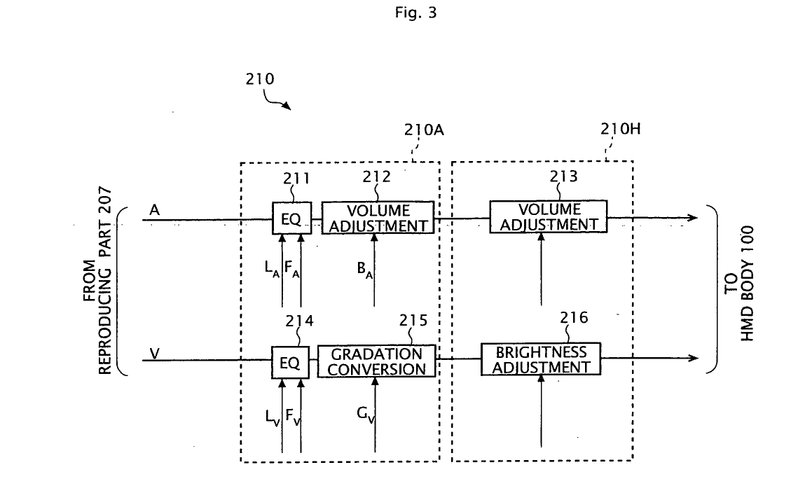

FIG. 3 is a functional block diagram of the signal processing part 210. As shown in FIG. 3, the signal processing part 210 has an automatic adjusting part 210A being automatically adjusted by the controlling part 208 and a manual adjusting part 210H being adjustable by the user.

An equalizer 211 acting on the audio signal (A), a volume adjusting part 212 acting on the audio signal (A), an equalizer 214 acting on the video signal (V), and a gradation converting part 215 acting on the video signal (V) are included in the automatic adjusting part 210A.

The equalizer 211 has a level adjusting function adjusting a level balance of each frequency component of the audio signal (A), and a phase adjusting function adjusting a phase of each frequency component of the audio signal (A). An input-output characteristic (input frequency-output level characteristic) L_{A} of the level adjusting function of the equalizer 211 and an input-output characteristic (input frequency-output phase characteristic) F_{A} of the phase adjusting function of the equalizer 211 are variable.

The volume adjusting part 212 has a function adjusting a level of the audio signal (A). A characteristic (level adjusting amount) B_{A} of the volume adjusting part 212 is variable.

The equalizer 214 has a level adjusting function adjusting a level balance of each frequency component of the video signal (V), and a phase adjusting function adjusting a phase of each frequency component of the video signal (V). An input-output characteristic (input frequency-output level characteristic) L_{V} of the level adjusting function of the equalizer 214 and an input-output characteristic (input frequency-output phase characteristic) F_{V} of the phase adjusting function of the equalizer 214 are variable.

The gradation converting part 215 performs a gradation converting process for each color component of the video signal (V) individually. An input-output characteristic (input brightness-output brightness) G_{V} of the gradation converting process for each color component is variable. Incidentally, respective functions of a color balance adjustment, a level adjustment, and a contrast adjustment of the video signal (V) are included in the gradation converting process.

On the other hand, a volume adjusting part 213 acting on the audio signal (A) and a brightness adjusting part 216 acting on the video signal (V) are included in the manual adjusting part 210H.

The volume adjusting part 213 has a function adjusting a level of the audio signal (A). A characteristic (level adjusting amount) of the volume adjusting part 213 is variable.

The brightness adjusting part 216 has a function adjusting a level (brightness) of the video signal (V). A characteristic (level adjusting amount) of the brightness adjusting part 216 is variable.

Among the above, the characteristic of the volume adjusting part 213 is adjusted by the controlling part 208 in accordance with a volume adjusting indication from the user. Besides, the characteristic of the brightness adjusting part 216 is also adjusted by the controlling part 208 in accordance with the brightness adjusting indication from the user. On the other hand, the respective characteristics L_{A}, F_{A}, B_{A}, L_{V}, F_{V}, G_{V} of the automatic adjusting part 210A are automatically set by the controlling part 208 in accordance with the usage status of the present system.

Hereinafter, the characteristics L_{A}, F_{A}, B_{A}, L_{V}, F_{V}, G_{V} set automatically are collectively called as “AV characteristics”, and a setting of the AV characteristic is called as an “AV setting”. Details of the AV setting are described later.

Next, the operations of the present system when the user designates the usage status are described.

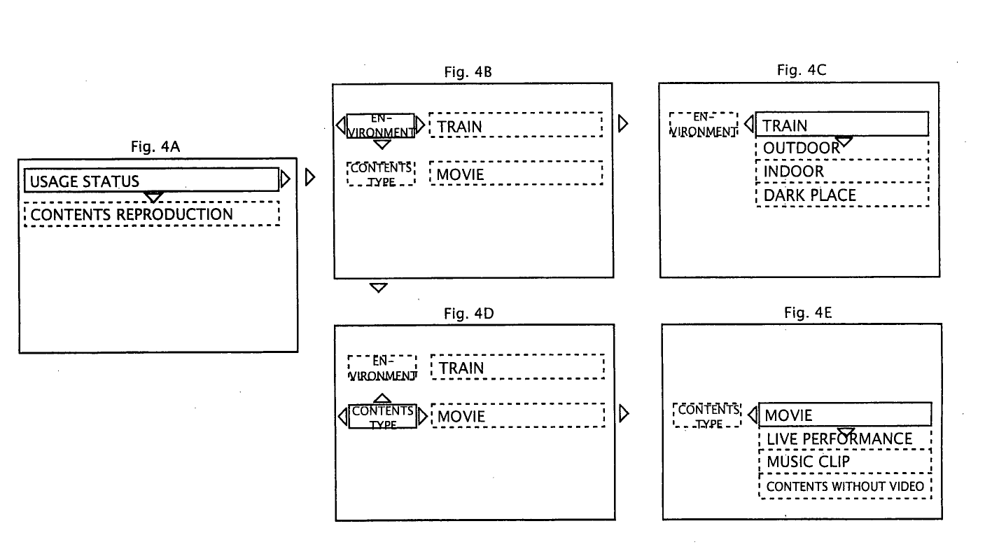

FIG. 4A to FIG. 4E are views showing displaying screens at the designation time of the usage status. FIG. 4A shows an operation screen, and various items are disposed in line in a longitudinal direction. There is an item of the “usage status” among one of these items.

During the operation screen (FIG. 4A) is displayed, the user operates the operating switch 205 in the longitudinal direction to match an indication destination of a cursor to the item of the “usage status”, further operates the operating switch 205 in a right direction, and the displaying screen is switched into a designating screen shown in FIG. 4B.

The designating screen (FIG. 4B) is to let the user designate an environment of the present system and a contents type to be an appreciating object independently, as the usage status of the present system.

Specifically, an item of the “environment” and an item of the “contents type” are disposed in line in the longitudinal direction on the designating screen (FIG. 4B). Besides, information showing the environment designated at the present moment (character information of “train” in FIG. 4B) and information showing the contents type designated at the present moment (character information of “movie” in FIG. 4B) are displayed on the designating screen (FIG. 4B).

The user operates the operating switch 205 in the longitudinal direction, matches the indication destination of the cursor to the item of the “environment”, and further, operates the operating switch 205 in the right direction during the designating screen (FIG. 4B) is displayed. Accordingly, choices of the environment are displayed in line in the longitudinal direction on the designating screen as shown in FIG. 4C. Here, the choices of the environment are four kinds of “train”, “outdoor”, “indoor”, and “dark place”.

When the user operates the operating switch 205 in the longitudinal direction, further presses the decision button of the operating switch 205 during the designating screen (FIG. 4C) is displayed, the controlling part 208 recognizes the environment indicated by the cursor at that time as the environment designated by the user. Accordingly, the user is able to designate any one of the four environments to the present system. The designation of the environment by the user is thereby completed.

When the user operates the operating switch 205 in the left direction during the designating screen (FIG. 4C) is displayed, the designating screen (FIG. 4C) is switched to the state in FIG. 4B.

The user operates the operating switch 205 in the longitudinal direction, matches the indication destination of the cursor to the item of the “contents type” (FIG. 4D), and further, operates the operating switch 205 in the right direction during the designating screen (FIG. 4B) is displayed. Accordingly, choices of the contents type are displayed in line in the longitudinal direction as shown in FIG. 4E. Here, the choices of the contents type are four kinds of “movie”, “live performance”, “music clip”, and “contents without video”.

When the user operates the operating switch 205 in the longitudinal direction, further presses the decision button of the operating switch 205 during the designating screen (FIG. 4E) is displayed, the controlling part 208 recognizes the contents type indicated by the cursor at that time as the contents type designated by the user. Accordingly, the user is able to designate any one of the four contents types to the present system. The designation of the contents type by the user is thereby completed.

Namely, the user is able to designate any one of 16 patterns of usage statuses including the four patterns of environments and the four patterns of contents types to the present system. The controlling part 208 recognizes the usage status designated by the user as the usage status of the present system as it is, and performs the AV setting in accordance with the usage status. The AV setting is performed every time when the usage status of the present system changes.

Next, the AV setting by the controlling part 208 is described.

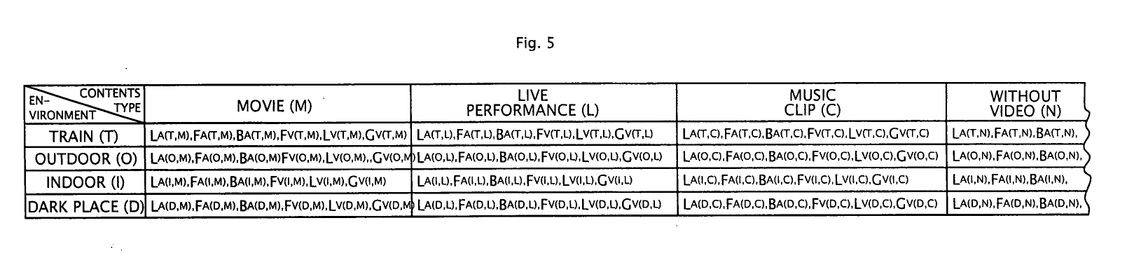

FIG. 5 is a view visualizing information for the AV setting stored by the controlling part 208 in advance. As shown in FIG. 5, the information for the AV setting includes 16 patterns of information of AV characteristics (the AV characteristics are the characteristics L_{A}, F_{A}, B_{A}, L_{V}, F_{V}, G_{V}) optimum for each of the above-stated 16 patterns of usage statuses. In the information for the AV setting, the information for the 16 patterns of AV characteristics are corresponded to the 16 patterns of usage statuses respectively.

Incidentally, in the following description, the environments of “train”, “outdoor”, “indoor”, “dark place” are represented by “T”, “O”, “I”, “D” respectively, and the contents types of “movie”, “live performance”, “music clip”, “contents without video” are represented by “M”, “L”, “C”, “N” respectively.

According to the represented characters, subscripts (T, M) are added to the AV characteristics (the characteristics L_{A}, F_{A}, B_{A}, L_{V}, F_{V}, G_{V}) optimum when the usage status is on the train (T) and the movie (M).

Besides, subscripts (T,L) are added to the AV characteristics (the characteristics L_{A}, F_{A}, B_{A}, L_{V}, F_{V}, G_{V}) optimum when the usage status is on the train (T) and the live concert (L).

Besides, subscripts (T,C) are added to the AV characteristics (the characteristics L_{A}, F_{A}, B_{A}, L_{V}, F_{V}, G_{V}) optimum when the usage status is on the train (T) and the music clip (C).

Besides, subscripts (T,N) are added to the AV characteristics (the characteristics L_{A}, F_{A}, B_{A}, L_{V}, F_{V}, G_{V}) optimum when the usage status is on the train (T) and the contents without video (N).

Besides, subscripts (O,M) are added to the AV characteristics (the characteristics L_{A}, F_{A}, B_{A}, L_{V}, F_{V}, G_{V}) optimum when the usage status is the outdoor environment (O) and the movie (M).

Besides, subscripts (O,L) are added to the AV characteristics (the characteristics L_{A}, F_{A}, B_{A}, L_{V}, F_{V}, G_{V}) optimum when the usage status is the outdoor environment (O) and the live concert (L).

Besides, subscripts (O,C) are added to the AV characteristics (the characteristics L_{A}, F_{A}, B_{A}, L_{V}, F_{V}, G_{V}) optimum when the usage status is the outdoor environment (O) and the music clip (C).

Besides, subscripts (O,N) are added to the AV characteristics (the characteristics L_{A}, F_{A}, B_{A}, L_{V}, F_{V}, G_{V}) optimum when the usage status is the outdoor environment (O) and the contents without video (N).

Besides, subscripts (I,M) are added to the AV characteristics (the characteristics L_{A}, F_{A}, B_{A}, L_{V}, F_{V}, G_{V}) optimum when the usage status is the indoor environment (I) and the movie (M).

Besides, subscripts (I,L) are added to the AV characteristics (the characteristics L_{A}, F_{A}, B_{A}, L_{V}, F_{V}, G_{V}) optimum when the usage status is the indoor environment (I) and the live concert (L).

Besides, subscripts (I,C) are added to the AV characteristics (the characteristics L_{A}, F_{A}, B_{A}, L_{V}, F_{V}, G_{V}) optimum when the usage status is the indoor environment (I) and the music clip (C).

Besides, subscripts (I,N) are added to the AV characteristics (the characteristics L_{A}, F_{A}, B_{A}, L_{V}, F_{V}, G_{V}) optimum when the usage status is the indoor environment (I) and the contents without video (N).

Besides, subscripts (D,M) are added to the AV characteristics (the characteristics L_{A}, F_{A}, B_{A}, L_{V}, F_{V}, G_{V}) optimum when the usage status is the dark place (D) and the movie (M).

Besides, subscripts (D,L) are added to the AV characteristics (the characteristics L_{A}, F_{A}, B_{A}, L_{V}, F_{V}, G_{V}) optimum when the usage status is the dark place (D) and the live concert (L).

Besides, subscripts (D,C) are added to the AV characteristics (the characteristics L_{A}, F_{A}, B_{A}, L_{V}, F_{V}, G_{V}) optimum when the usage status is the dark place (D) and the music clip (C).

Besides, subscripts (D,N) are added to the AV characteristics (the characteristics L_{A}, F_{A}, B_{A}, L_{V}, F_{V}, G_{V}) optimum when the usage status is the dark place (D) and the contents without video (N).

Incidentally, the controlling part 208 reads the AV characteristic corresponding to the recognized usage status, from the above-stated information for the AV setting (FIG. 5) to perform the AV setting. For example, when the recognized usage status is on the train M and the movie (M), the characteristics L_{A} (T, M), F_{A} (T, M), B_{A} (T, M), L_{V} (T, M), F_{V} (T, M), G_{V} (T, M) are read. The controlling part 208 sets the characteristics L_{A} (T, M), F_{A} (T, M) to the equalizer 211 of the automatic adjusting part 210A (refer to FIG. 3), sets the characteristic B_{A} (T, M) to the volume adjusting part 212, sets the characteristics L_{V} (T, M), F_{V} (T, M) to the equalizer 214, and sets the characteristic G_{V} (T, M) to the gradation converting part 215. The equalizer 211, the volume adjusting part 212, the equalizer 214, and the gradation converting part 215 perform the signal processes according to the characteristics L_{A} (T, M), F_{A} (T, M), B_{A} (T, M), L_{V} (T, M), F_{V} (T, M), G_{V} (T, M) until the next setting is performed again. The AV setting by the controlling part 208 is thereby completed.

Incidentally, contents of the information for the AV setting (FIG. 5), namely, the 16 patterns of AV characteristics (the characteristics L_{A}, F_{A}, B_{A}, L_{V}, F_{V}, G_{V}) optimum for each of the 16 patterns of usage statuses may be determined based on an experiment and a simulation by a manufacturer of the present system. It is desirable that, for example, the following items are reflected on the decision.

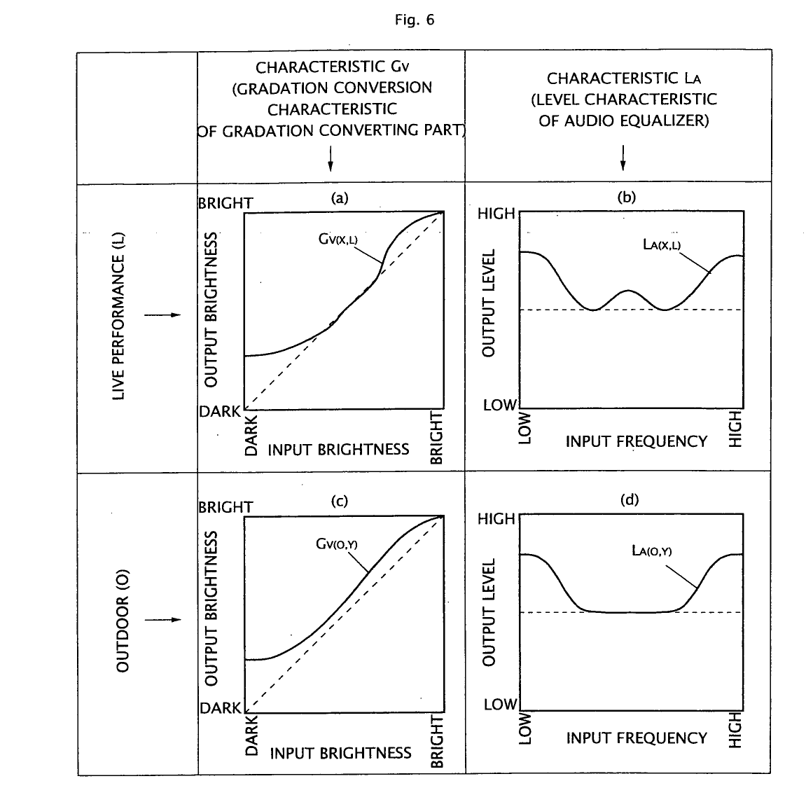

When the contents type is the live performance (L), the characteristic G_{V} (X, L) corresponding to the live performance (L) is determined to be the characteristic in which a low brightness component of the video signal is pulled up toward high brightness side compared to the characteristic G_{V} (X, Y) corresponding to the other contents type because there is a high possibility that the video is dark. FIG. 6(a) is an example of such characteristic G_{V} (X, L).

When the contents type is the live performance (L), it is necessary to increase presence of sound, and therefore, the characteristic L_{A} (X, L) corresponding to the live performance (L) is determined to be the characteristic in which levels of a low frequency component and a high frequency component of the audio signal is pulled up to high level compared to the characteristic L_{A} (X, Y) corresponding to the other contents type. Besides, the characteristic L_{A} (X, L) corresponding to the live performance (L) is determined to be the characteristic in which a middle frequency component corresponding to a singing voice is pulled up to high level compared to the characteristic L_{A}(X, Y) corresponding to the other contents type, so as to make the singing voice easy to listen to. FIG. 6(b) is an example of such characteristic L_{A} (X, L).

When the environment is the outdoor environment (O), the characteristic G_{V} (O, Y) corresponding to the outdoor environment (O) is determined to be the characteristic in which all of the brightness components of the video signal are pulled up toward high brightness side, and a contrast of the video signal is increased compared to the characteristic G_{V} (X, Y) corresponding to the other environment because a possibility that an external world is bright is high. FIG. 6(c) is an example of such characteristic G_{V} (O, Y).

When the environment is the outdoor environment (O), a necessity to prevent sound leakage is low, and therefore, the characteristic L_{A} (O, Y) corresponding to the outdoor environment (O) is determined to be the characteristic in which the low frequency component and the high frequency component of the audio signal are pulled up to high level compared to the characteristic L_{A} (X, Y) corresponding to the other environment. FIG. 6(d) is an example of such characteristic L_{A} (O, Y).

When the contents type is the contents without video (N), it is difficult to obtain the presence, and therefore, the characteristic G_{V} (X, N) corresponding to the contents without video (N) is determined to be the characteristic in which the levels of the low frequency component and the high frequency component of the audio signal are more increased compared to the characteristic G_{V} (X, Y) corresponding to the other contents type.

When the environment is the dark place (D), visibility of the user shifts toward a blue side, and therefore, the characteristic G_{V} (D, Y) corresponding to the dark place (D) is determined to be the characteristic in which a color balance of the video signal is pulled toward a red side compared to the characteristic G_{V} (X, Y) corresponding to the other environment.

When the environment is the dark place (D), the user tends to manually set a volume adjustment of the sound to be suppressed, and therefore, the characteristic L_{A} (D, Y) corresponding to the dark place (D) is determined to be the characteristic in which the levels of the low frequency component and the high frequency component of the audio signal are more increased compared to the characteristic L_{A} (X, Y) corresponding to the other environment.

As stated above, the user of the present system designates the usage status of the present system to the present system instead of performing the AV setting manually (refer to FIG. 4A to FIG. 4E). The controlling part 208 of the present system automatically performs the AV setting of the signal processing part 210 in accordance with the designated usage status (refer to FIG. 5).

As it is obvious from FIG. 4A to FIG. 4E, the work of the user to designate the usage status is easy compared to the work when the AV setting is performed manually because any trial and error are not necessary. According to the present system, it is possible to reduce the trouble of the user relating to the AV setting.

Incidentally, in the present system, four kinds of choices of “movie”, “live performance”, “music clip”, and “contents without video” are prepared as the choices of the contents type, but it is not limited to the above. For example, “movie 1”, “movie 2”, “movie 3”, “jazz 1”, “jazz 2”, “pops 1”, “classic 1”, “classic 2”, and so on may be prepared.

Besides, in the present system, the process is performed for the video signal when the brightness adjustment of the video is performed, but a brightness adjusting indication may be given to the video displaying element 102M.

### Second Embodiment

Hereinafter, a second embodiment of the present invention is described. The present embodiment is also an embodiment of the HMD system. Here, different points from the first embodiment are described.

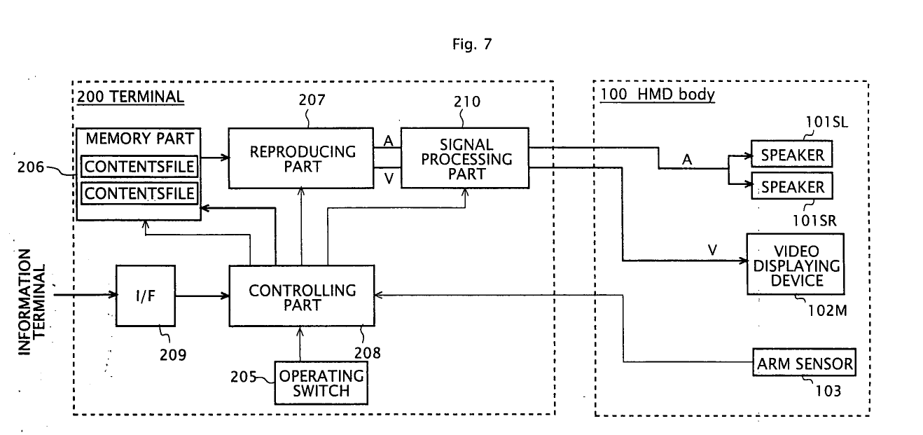

FIG. 7 is a functional block diagram showing an electrical configuration of a system of the present embodiment. A constitutional different point is that an arm sensor 103 is provided at the HMD body 100, as shown in FIG. 7.

The arm sensor 103 is made up of a mechanical switch and so on provided at a rotating part of the supporting arm 112a shown in FIG. 1, and is to detect whether the displaying part 102 is disposed at the position shown by the solid line in FIG. 1 (the position correctly facing the viewing eye) or not. A detecting signal of the arm sensor 103 is given to the controlling part 208 of the terminal 200, and the controlling part 208 identifies whether a video display of the present system is valid or not (effectiveness of the video display) by this detecting signal. The controlling part 208 changes the contents of the AV setting by using the above.

Specifically, the controlling part 208 performs the AV setting similar to the first embodiment during the period when the video display is valid, and performs the AV setting putting more emphasis on the sound than the video during the period when the video display is invalid. For example, the AV setting in which the levels of the low frequency component and the high frequency component of the audio signal are more increased is employed in the AV setting putting emphasis on the sound.

Accordingly, in the present system, the user only moves the displaying part 102 with hand, and thereby, the AV characteristic is switched automatically. It is therefore possible to perform the more accurate AV setting while suppressing the user's trouble as same as in the first embodiment.

### Third Embodiment

Hereinafter, a third embodiment of the present invention is described. The present embodiment is also an embodiment of the HMD system. Here, only different points from the first embodiment are described.

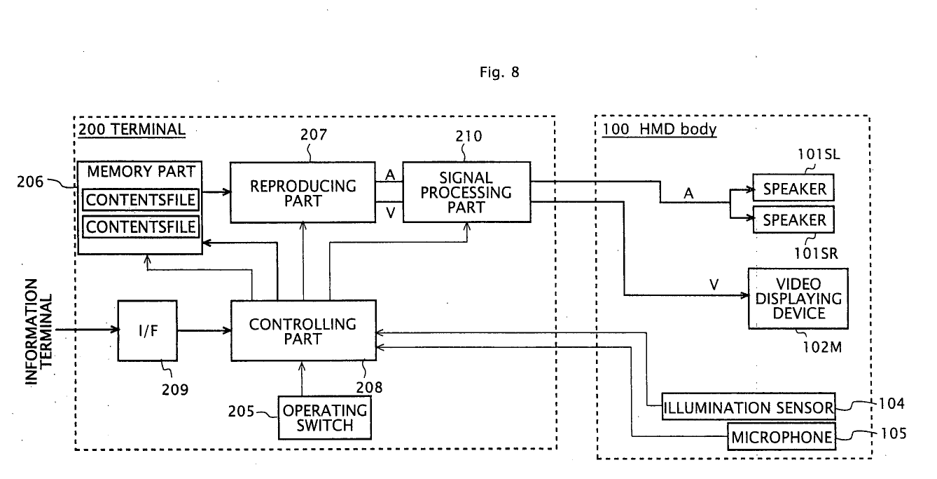

FIG. 8 is a functional block diagram showing an electrical configuration of a system of the present embodiment. As shown in FIG. 8, a constitutional different point is that an illumination sensor 104 and a microphone 105 are provided at the HMD body 100.

The illumination sensor 104 is, for example, provided at an external side of the displaying part 102 shown in FIG. 1, and is an illumination sensor detecting illumination of light incident from external to the viewing eye. A detecting signal of the illumination sensor 104 is given to the controlling part 208 of the terminal 200, and the controlling part 208 recognizes a level of the external illumination by this detecting signal.

The microphone 105 is, for example, provided at an outer package and so on of the headphones 101L, 101R shown in FIG. 1, and is a microphone detecting a level of an environmental sound at an external side of the headphones 101L, 101R. An output signal of the microphone 105 is given to the controlling part 208 of the terminal 200, and the controlling part 208 recognizes the level of the environmental sound by the output signal. The controlling part 208 reduces the user's trouble by using the above.

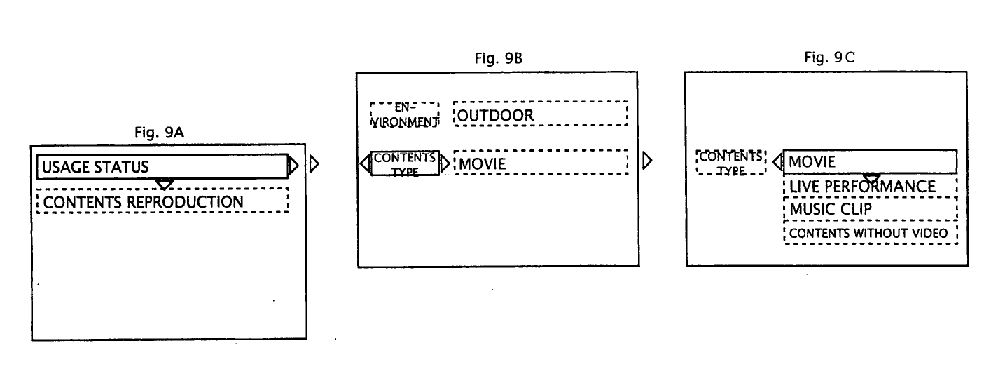

Specifically, when the level of the external illumination is enough high, it is obvious that the environment of the present system is the “outdoor” without the user's designation, and therefore, the controlling part 208 excludes the three choices of “train”, “indoor”, and “dark place” from the choices of the environment, as shown in FIGS. 9A, 9B, 9C.

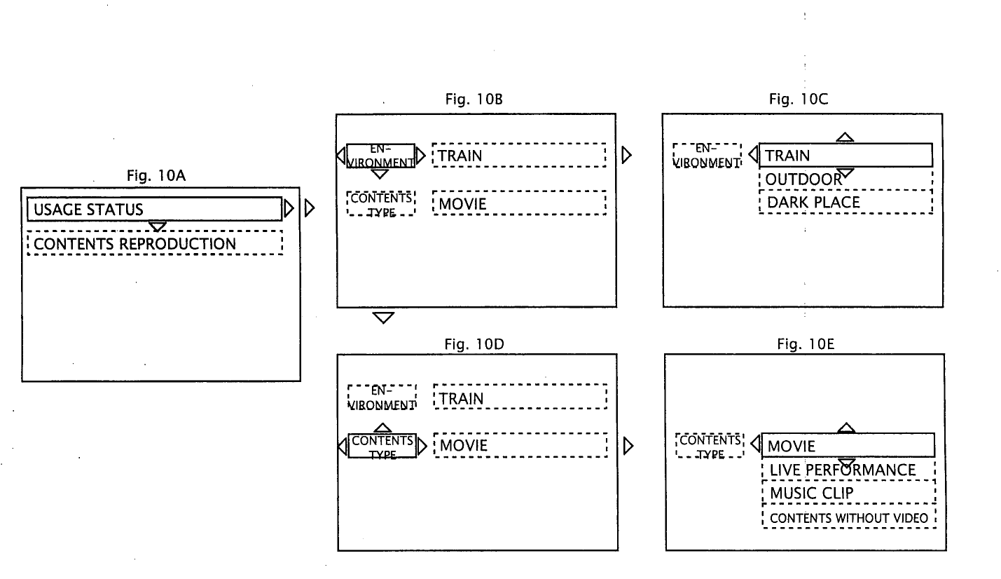

Besides, when the level of the environmental sound is enough high, it is obvious that the environment of the present system is other than the “indoor” environment without the user's designation, and therefore, the controlling part 208 excludes the “indoor” from the choices of the environment, as shown in FIGS. 10A to 10E.

As stated above, the user's trouble is reduced if unnecessary items are excluded from the choices.

Incidentally, the controlling part 208 of the present system reduces the number of choices by using the illumination sensor 104 and the microphone 105, but narrowing down of the usage status in detail may be performed.

For example, even if the information input by the user is the “outdoor”, it is possible to automatically discriminate between a “fine weather outdoor” and a “cloudy weather outdoor” by using the detecting signal of the illumination sensor 104. In that case, it is possible to use the different AV characteristics properly between the “fine weather outdoor” and the “cloudy weather outdoor”.

Besides, even if the information input by the user is the “dark place”, it is possible to automatically discriminate between a “dark place with noise” and a “dark place without noise” by using the output signal of the microphone 105. In that case, it is possible to use the different AV characteristics properly between the “dark place with noise” and the “dark place without noise”.

Besides, the present system is the one modifying the system of the first embodiment, but the system of the second embodiment may be modified similarly.

### Other Embodiments

Incidentally, the user inputs the contents type in the above-stated systems of the respective embodiments, but the controlling part 208 may automatically discriminate the contents type from additional information and so on of the contents file.

Besides, the function automatically setting the AV characteristic in accordance with the usage status is mounted on the above-stated systems of the respective embodiments, but both the function automatically setting the AV characteristic and the function making the user set the AV characteristic manually may be mounted.

Besides, the function full-automatically setting the AV characteristic in accordance with the usage status is mounted on the above-stated systems of the respective embodiments, but a function semi-automatically setting the AV characteristic may be mounted. For example, the kinds of the AV characteristics which can be manually set by the user may be narrowed down in accordance with the usage status of the system.

Besides, a part or all of the functions of the terminal 200 may be mounted at the HMD body 100 side, in the above-stated systems of the respective embodiments.

Besides, the HMD system made up of the HMD with headphone and the contents reproducing apparatus is described in the above-stated respective embodiments, but the present invention is applicable for a headphone system made up of a contents reproducing apparatus with displaying part and a headphone, and an HMD/headphone system made up of an HMD without headphone, a headphone, and a contents reproducing apparatus, and so on.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A mobile signal processing apparatus, comprising:
an audio adjusting unit adjusting audio output from mobile acoustic devices;
an image adjusting unit adjusting an image displayed on a mobile displaying device; and
a deciding unit deciding a combination between a setting of the audio adjusting unit and a setting of the image adjusting unit in accordance with a usage status of the mobile acoustic devices and the mobile displaying device.

2. The mobile signal processing apparatus according to claim 1, wherein
the deciding unit recognizes the usage status by an input from a user.

3. The mobile signal processing apparatus according to claim 1, wherein
the deciding unit recognizes the usage status by a signal from a sensor provided at least one of the mobile acoustic devices and the mobile displaying device.

4. A wearable display, comprising:
mobile acoustic devices;
a mobile displaying device;
a mounting unit mounting the mobile acoustic devices and the mobile displaying device at a head part of a user; and
the mobile signal processing apparatus described in claim 1 adjusting audio output from the mobile acoustic devices and adjusting an image displayed on the mobile displaying device.

5. A mobile signal processing apparatus, comprising:
an audio adjusting unit adjusting audio output from mobile acoustic devices;
an image adjusting unit adjusting an image displayed on a mobile displaying device; and
a deciding unit deciding a combination between a setting of the audio adjusting unit and a setting of the image adjusting unit in accordance with both a usage environment of the mobile acoustic devices and the mobile displaying device, and a type of contents to be appreciated.

6. The mobile signal processing apparatus according to claim 5, wherein
the deciding unit recognizes the usage environment and the type of the contents to be appreciated by an input from a user.

7. The mobile signal processing apparatus according to claim 5, wherein
the deciding unit recognizes the usage environment by a signal from a sensor provided at least one of the mobile acoustic devices and the mobile displaying device.

8. A wearable display, comprising:
mobile acoustic devices;
a mobile displaying device;
a mounting unit mounting the mobile acoustic devices and the mobile displaying device at a head part of a user; and
the mobile signal processing apparatus described in claim 5 adjusting audio output from the mobile acoustic devices and adjusting an image displayed on the mobile displaying device.

9. A wearable display, comprising:
mobile acoustic devices;
a mobile displaying device;
a mounting unit mounting the mobile acoustic devices and the mobile displaying device at a head part of a user; and
the mobile signal processing apparatus described in claim 2 adjusting audio output from the mobile acoustic devices and adjusting an image displayed on the mobile displaying device.

10. A wearable display, comprising:
mobile acoustic devices;
a mobile displaying device;
a mounting unit mounting the mobile acoustic devices and the mobile displaying device at a head part of a user; and
the mobile signal processing apparatus described in claim 3 adjusting audio output from the mobile acoustic devices and adjusting an image displayed on the mobile displaying device.

11. A wearable display, comprising:
mobile acoustic devices;
a mobile displaying device;
a mounting unit mounting the mobile acoustic devices and the mobile displaying device at a head part of a user; and
the mobile signal processing apparatus described in claim 6 adjusting audio output from the mobile acoustic devices and adjusting an image displayed on the mobile displaying device.

12. A wearable display, comprising:
mobile acoustic devices;
a mobile displaying device;
a mounting unit mounting the mobile acoustic devices and the mobile displaying device at a head part of a user; and
the mobile signal processing apparatus described in claim 7 adjusting audio output from the mobile acoustic devices and adjusting an image displayed on the mobile displaying device.
